(19) United States
(12) Patent Application Publication
(10) Pub. No.: US 2008/0244404 A1
(43) Pub. Date: Oct. 2, 2008

(54) GRAPHICAL METHOD FOR DISPLAYING AUXILIARY RELATIONSHIPS BETWEEN OBJECTS

(75) Inventors: Jin Li, Toronto (CA); David K. Modjeska, Toronto (CA)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/695,137

(22) Filed: Apr. 2, 2007

(51) Int. Cl. G06F 3/00

(52) U.S. Cl. 715/713

(57) ABSTRACT

A method implemented in a scalable auxiliary graph for simultaneously displaying both traditional hierarchical information and auxiliary information at the same time. The method provides for a scalable auxiliary graph that shows feature interdependencies between a selected feature or sub-feature and any related interdependent primary features and/or sub-features. Here, the scalable auxiliary graph includes a visual anchor connecting the plurality of primary features and sub-features. A visual link is used to connect a currently selected feature or sub-feature to the visual anchor. Visual connector lines are used to link the visual anchor to related interdependent primary features or sub-features. This allows the user to simultaneously visualize relationship between the selected feature and any related interdependent primary features and/or sub-features.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

This invention relates generally to a graphical user interface for showing interdependencies between data objects and, more specifically to a method of selecting and displaying interdependent hierarchical and auxiliary object relationships.

2. Description of Background

When installing a software application on a computer system an end-user is often presented with a list of available features. Understanding interdependent object relationships among the selectable features of the software application can be confusing. Typically a list is displayed in a tree view, which shows hierarchical relationships among the features. These features are divided into groups, which appear as top-level nodes in the tree. When a user selects a top-level feature (e.g., check a box beside a feature), all of the feature's nested sub-features are automatically selected. When a user selects one or more sub-features, the parent nodes of sub-features are partially checked to reflect the user's selection. However, if there are interdependencies among features in two or more top-level feature groups, the user may overlook these interdependencies, except that most installation programs automatically selects some apparently unrelated features. Users have difficulty visualizing and understanding why the installation program prevents them from deselecting a feature on which other selected features have a dependency.

### SUMMARY

In an exemplary embodiment, a computer implemented method of graphically displaying hierarchical and auxiliary feature relationships in a computer software installation application that comprises providing a plurality of top-level features representing various components of an application program and providing a plurality of sub-features representing various inter-dependent sub-features of the application program. The method identifies feature interdependencies among the plurality of top-level features and sub-features. With this information, the method provides a graphical user interface arranging one or more top-level features and sub-features in a hierarchical tree-view, wherein top-level features are provided in a hierarchical list that is expandable to include sub-features. The method further provides user selection of one or more top-level features and/or sub-features, wherein the user selects a feature to install. These selectable features are provided in a scalable auxiliary graph that shows feature interdependencies between selected top-level features or sub-features and any related interdependent top-level features and sub-features, wherein the scalable auxiliary graph includes: a visual anchor connecting the plurality of top-level features and sub-features; a visual link connecting a currently selected feature to the visual anchor; a plurality of visual connector lines linking the visual anchor to any related interdependent top-level features or sub-features so that the user is made aware of interrelationships between the selected feature and any related interdependent top-level features and sub-features; and automatically adjusting and scaling the auxiliary graph such that the visual anchor, visual link, and the plurality of visual connector lines automatically re-plot based on any additional user selections.

In another exemplary embodiment, a computer-implemented method of displaying an auxiliary graph of hierarchical and auxiliary object relationships, wherein the method comprises providing a plurality of primary data objects representing various components of a network application and providing a plurality of auxiliary data objects representing various inter-dependent sub-components of the network application. The feature interdependencies among the plurality of primary data objects and auxiliary data objects are identified. This information is provided in a graphical user interface arranging one or more primary and auxiliary data objects in a hierarchical tree-view, wherein primary data objects are provided in a hierarchical ranked list that is expandable to include auxiliary data objects. Also provided is user selection of one or more primary and auxiliary data objects, wherein the user selects an object to include. Further, a scalable auxiliary graph that shows feature interdependencies between selected primary or auxiliary data objects and any related interdependent primary and auxiliary data objects is provided. The scalable auxiliary graph includes a visual anchor connecting the plurality of primary and auxiliary data objects; a visual link connecting a currently selected data object to the visual anchor; a plurality of visual connector lines linking the visual anchor to any related interdependent primary and auxiliary data objects so that the user is made aware of interrelationships between the selected data object and any related interdependent primary and auxiliary data objects; and automatically adjusting and scaling the auxiliary graph such that the visual anchor, visual link, and plurality of visual connector lines automatically re-plot in accordance with any additional user selections.

Additional features and advantages are realized through the techniques of the various exemplary embodiments. Other embodiments and aspects are described in detail herein and are considered a part of the claimed invention. For a better understanding of the embodiments with advantages and features, refer to the description and to the drawings.

### TECHNICAL EFFECTS

As a result of the summarized embodiments, technically a solution is achieved that provides a method for the graphical display of auxiliary relationships among a plurality of data objects or features. This method is implemented in a scalable auxiliary graph for simultaneously displaying both traditional hierarchical information and auxiliary information at the same time. The auxiliary graph shows feature interdependencies between selected top-level features and/or nested sub-features and any related interdependent top-level features and/or nested sub-features. Here, the scalable auxiliary graph includes a visual anchor connecting the plurality of top-level features and nested sub-features. A visual link is used to connect a currently selected top-level feature or nested sub-feature to the visual anchor. Visual connector lines are used to link the visual anchor to each related interdependent top-level features or nested sub-features. This allows the user to simultaneously visualize interrelationships between the selected feature and any related interdependent top-level features or nested sub-features. The method automatically adjusts and scales the auxiliary graph such that the visual anchor, visual link, and the plurality of visual connector lines automatically re-plot based on any additional user selections.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flowchart of an exemplary embodiment of the method of displaying hierarchical and auxiliary feature relationships in a computer software application.

FIG. 2 illustrates one example of the output provided by the embodiment described in FIG. 1.

FIG. 3 illustrates another example of the output provided by the embodiment described in FIG. 1.

The detailed description explains the preferred embodiments of the invention, together with advantages and features, by way of example with reference to the drawings.

### DETAILED DESCRIPTION

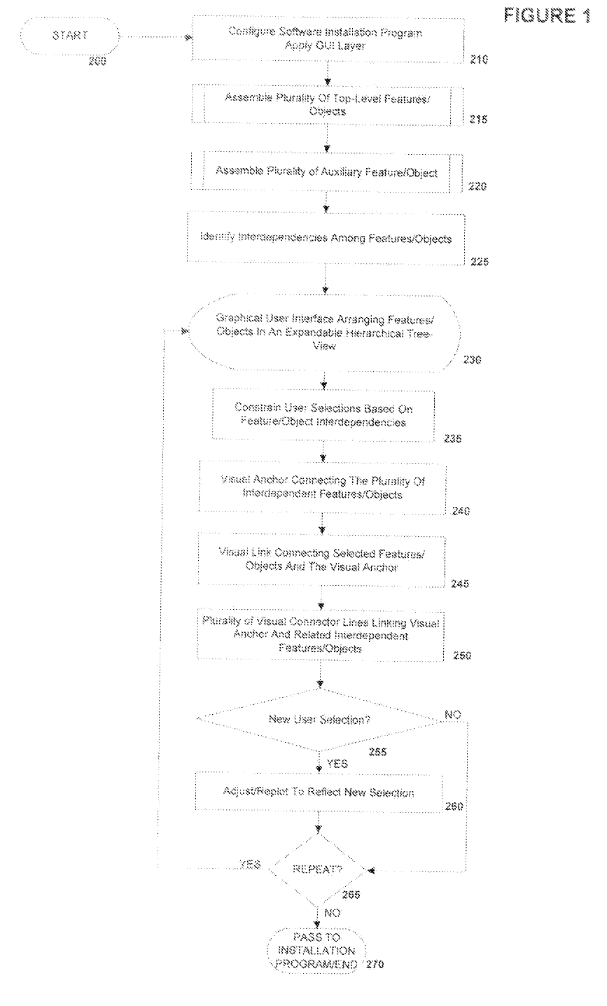

In an exemplary embodiment, a method of augmenting the display of hierarchical relationships among objects, by adding a visualization of auxiliary relationships among objects is described herein. Turning now to the drawings in greater detail, it will be seen that in FIG. 1 when the process starts, 200, a graphical user interface (GUI) is configured along with a software installation program at step 210. In an exemplary embodiment, as the software is configured for installation on the personal computer system, a plurality of top-level features are assembled in a repository and readied for installation at step 215. Also, a plurality of top-level features are assembled and readied for installation at step 220. At step 225, the system identifies interdependencies among the various top-level features and nested sub-features. The identification of interdependencies among various features allows the system to inform the end-user about which features are interdependent.

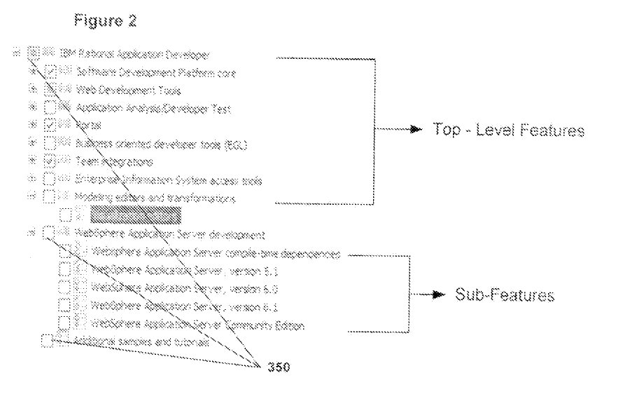

The system uses the GUI to arrange the top-level features and nested sub-features in an interactive expandable tree-view at step 230. The system lists the features in a hierarchical ranked order. Each feature includes a dialog box 350 so that it is selectable as shown in FIG. 2. Once the end-user selects a top-level feature, any related sub-features appear nested below the selection, as shown in FIG. 2. Each sub-feature is also selectable. Depending on the user selection, other features may be automatically selected or recommended for selection as shown at step 235 in FIG. 1. Once other features are automatically selected, constraints are put in place such that end-users cannot deselect features that are interdependent upon each other.

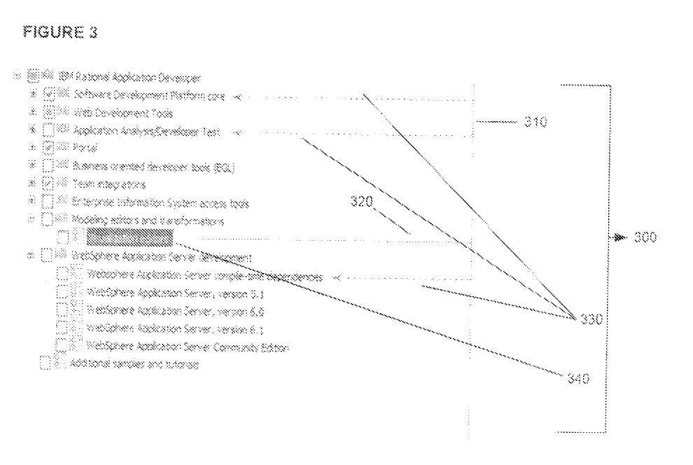

As features are selected, the graphical user interface plots an auxiliary graph 300 that shows feature interdependencies as shown in FIG. 3. Referring to FIGS. 1 and 3, in an exemplary embodiment, when the end-user selects a feature, a visual anchor 310 is plotted, as described in step 240, for indicating the connection between the plurality of interdependent top-level features and nested sub-features. A visual link is 320 drawn from the selected feature to the visual anchor 310, as described in step 245. Next, a plurality of visual connector lines 330 are drawn to link the visual anchor 310 to any interdependent top-level features and/or nested sub-features, described in step 250. Therefore, as shown in FIG. 3, the solid vertical line 310 is a visual anchor wherein, when the user selects or highlights the sub-feature, “visualization editor” the process draws a solid horizontal line 320 that is a visual link connecting the feature to the visual anchor 310. Next, the process automatically draws dashed, horizontal, visual connector lines 330 from the visual anchor to any interdependent features. This auxiliary graph 300 allows the user to better understand and respond to the constraints imposed by auxiliary object relationships by allowing the user to simultaneously visualize hierarchical and auxiliary object relationships.

The exemplary embodiment, the auxiliary graph 300 is expandable and scalable. As the end-user selects different features, the visual anchor 310, link 320 and connector lines 330 are re-plotted to display interdependencies between the newly selected features. When a top-level feature group is selected, the auxiliary graph 300 expands to display any associated sub-features. As new features are selected, the entire display re-plots to show the additional features and interdependencies.

Referring to FIGS. 2 and 3 for example, as the user points to the feature “Visualizing editors” a visual link 320 is plotted between the feature and the visual anchor 310. Corresponding visual connector lines 330 are drawn to other interdependent features that must also be installed along with the “Visualization editors” feature. Therefore, in this example, “Visualization editors” is interdependent on “Software Development Platform Core,” “Application Analysis/Developer Test,” and “Websphere Application Server Compile-time Dependencies.” When the user selects “Visualization editors,” related features are automatically selected. By looking at the auxiliary graph 300, the user can easily understand the interrelationships and reasons for automatically selecting certain sub-features.

Further referring to FIGS. 2 and 3, constraints may be put in place to limit user manipulation of the install process. For example, if the user deselects “Application Analysis/Developer Test,” the installation program might impose constraints including at least one of forbidding the action, automatically deselecting related features and sub-features, or deselecting all features. The user will be able to clearly understand why such actions are taken by simply referring to the feature interdependencies plotted by the auxiliary graph 300.

Again referring to FIGS. 1 and 3, once the end-user has selected a feature to be installed and interdependencies are shown to user via the auxiliary graph 300, the user may choose keep these selections and move on the next feature. As the user selects additional features as described at step 255, the auxiliary graph 300 expands re-plots to show these new interdependencies. The process is repeated, as described in step 265, until the user has made all the features selections of his or her choice. Once the feature selections are complete, the software installation process begins and the auxiliary graphical display process ends, as described at step 270.

In the exemplary embodiment described above, this process is appropriate for software installation applications (and analogous tasks). However, this process and user interface (UI) is also applicable to any application where it is useful for the user to visualize hierarchical and auxiliary object relationships. For example, this process is applicable to other problem domains, such as call graphs, database servers, management of network servers, and dependencies in building source code. The process allows two types of data to be shown at once, hierarchical data on one side and network data on the other. Therefore, global structure can be shown on the network side and locally selectable structure can be shown on the hierarchical side. This ability to simultaneously display both the global structure and locally selectable structure allows the auxiliary graph 300 to be flexible and scalable. These features allow the auxiliary graph 300 to have a more efficient and task-focused structure. Furthermore, the auxiliary graph 300 keeps both primary information and auxiliary information in the same display, thereby facilitating the end-user's ability to scan the information and instantly understand it.

In a further exemplary embodiment, the method is applicable to an information technology or computer network management system. The top-level features and nested sub-features could also be data objects or interdependent components of a computer network. The method allows the GUI to display an auxiliary graph 300 showing interdependencies among various data objects in a computer network as the objects are being installed as described, for example, in FIG. 1. The method is also useful for displaying computer network topology maps and auxiliary tree views.

In still a further exemplary embodiment, the method is applicable to a database management system. The top-level features and nested sub-features could also be data objects or interdependent information components stored in a computer database. The method allows the GUI to display auxiliary graph 300 showing interdependencies among various information components stored in a computer database as the objects are being stored, similar to the process described, for example, in FIG. 1. The method is useful for displaying database topology maps and auxiliary tree views.

The capabilities of the present invention can be implemented in software, firmware, hardware or some combination thereof.

As one example, one or more aspects of the exemplary embodiments can be included in an article of manufacture (e.g., one or more computer program products) having, for instance, computer usable media. The media has embodied therein, for instance, computer readable program code means for providing and facilitating the capabilities of the exemplary embodiments. The article of manufacture can be included as a part of a computer system or sold separately.

Additionally, at least one program storage device readable by a machine, tangibly embodying at least one program of instructions executable by the machine to perform the capabilities of the exemplary embodiments can be provided.

The flow diagrams depicted herein are just examples. There may be many variations to these diagrams or the steps (or operations) described therein without departing from the spirit of the exemplary embodiments. For instance, the steps may be performed in a differing order, or steps may be added, deleted or modified. All of these variations are considered a part of the exemplary embodiments.

Although described with particular reference to a method of displaying hierarchical and auxiliary feature/object relationships in the Windows® operating system, published by the Microsoft® Corporation of Redmond, Wash., the claimed subject matter can be implemented in any information technology (IT) system where it is desirable to display hierarchical and auxiliary feature/object relationships. Those with skill in the computing arts will recognize that the disclosed embodiments have relevance to a wide variety of computing environments in addition to those described below. In addition, the method of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC), server or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example, the following: a portable computer diskette, a random access memory (RAM), a read-only memory (ROM), an erasable programmable read-only (EPROM or flash memory), and a portable compact disk read-only memory or another suitable medium upon which a program and/or data may be stored.

The method is executable on exemplary computing system architecture, such as a desktop computer including a monitor, a keyboard and a mouse, which together facilitate human interaction with the computer. The mouse, keyboard and monitor are operable with the computer to facilitate end-user interaction with a GUI executing on the computer. Attached to computer is a hard drive storage component capable of storing at least one of an installed software application, network data object components and interdependent information components stored in a database.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer implemented graphical method of simultaneously displaying hierarchical and auxiliary feature relationships in a computer software installation application, the method comprising:
providing a plurality of top-level features representing various components of an application program;
providing a plurality of sub-features representing various inter-dependent sub-features of the application program;
identifying feature interdependencies among the plurality of top-level features and sub-features;
providing a graphical user interface arranging one or more top-level features and sub-features in a hierarchical tree-view, wherein top-level features are provided in a hierarchical list that is expandable to include sub-features;
providing user selection of one or more top-level features and/or sub-features, wherein the user selects a feature to install; and
providing a scalable auxiliary graph that simultaneously shows feature interdependencies between selected top-level features or sub-features and any related interdependent top-level features and sub-features, wherein the scalable auxiliary graph includes:
a visual anchor connecting the plurality of top-level features and sub-features;
a visual link connecting a currently selected feature to the visual anchor;
a plurality of visual connector lines linking the visual anchor to any related interdependent top-level features or sub-features so that the user is made aware of interrelationships between the selected feature and any related interdependent top-level features and sub-features; and
automatically adjusting and scaling the auxiliary graph such that the visual anchor, visual link, and the plurality of visual connector lines automatically re-plot based on any additional user selections.

2. The method of claim 1 wherein, when the user selects top-level features and sub-features any related interdependent top-level features and sub-features are automatically selected and the auxiliary graph is automatically re-plotted to show the interdependencies.

3. The method of claim 2 wherein, if the user attempts to de-select an interdependent sub-feature, the installation program imposes constraints including at least one of forbidding the action, automatically deselecting related features, and deselecting all features.

4. The method of claim 1 wherein the plurality of visual connector lines comprise dashed, horizontal, arrow lines and the visual anchor is a solid vertical line.

5. A computer implemented graphical method of simultaneously displaying hierarchical and auxiliary object relationships, the method comprising:
providing a plurality of primary data objects representing various components of a network application;
providing a plurality of auxiliary data objects representing various interdependent sub-components of the network application;
identifying feature interdependencies among the plurality of primary data objects and auxiliary data objects;
providing a graphical user interface arranging one or more primary and auxiliary data objects in a hierarchical tree-view, wherein primary data objects are provided in a hierarchical ranked list that is expandable to include auxiliary data objects;
providing user selection of one or more primary and auxiliary data objects, wherein the user selects an object to include; and
providing a scalable auxiliary graph that shows feature interdependencies between selected primary or auxiliary data objects and any related interdependent primary and auxiliary data objects, wherein the scalable auxiliary graph includes:
a visual anchor connecting the plurality of primary and auxiliary data objects;
a visual link connecting a currently selected data object to the visual anchor;
a plurality of visual connector lines linking the visual anchor to any related interdependent primary and auxiliary data objects so that the user is made aware of interrelationships between the selected data object and any related interdependent primary and auxiliary data objects; and
automatically adjusting and scaling the auxiliary graph such that the visual anchor, visual link, and plurality of visual connector lines automatically re-plot in accordance with any additional user selections.
